(19) United States
(12) Patent Application Publication
(10) Pub. No.: US 2007/0121052 A1
(43) Pub. Date: May 31, 2007

(54) Array substrate and liquid crystal display panel

(76) Inventors: Hiroharu Inoue, Fukaya-shi (JP); Takeshi Yamamoto, Fukaya-shi (JP); Atsuyuki Manabe, Fukaya-shi (JP); Masumi Manabe, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/543,879

(22) Filed: Oct. 6, 2006

(30) Foreign Application Priority Data
Nov. 30, 2005 (JP) 2005-346816

(51) Int. Cl. G02F 1/1339

(52) U.S. Cl. 349/156

(57) ABSTRACT

An array substrate comprises a substrate, an underlayer including a plurality of switching elements formed on the substrate, a plurality of colored layers formed on the substrate and the switching elements, and a plurality of pixel electrodes provided on the colored layers and connected to the switching elements via contact holes formed in the colored layers, and a plurality of columnar spacers provided on the underlayer. The underlayer includes a plurality of same-structure portions extending perpendicular to the substrate. The columnar spacers are provided on the same-structure portions.

### CROSS-REFERENCE TO RELATED APPLICATIONS

This application is based upon and claims the benefit of priority from prior Japanese Patent Application No. 2005-346816, filed Nov. 30, 2005, the entire contents of which are incorporated herein by reference.

### BACKGROUND OF THE INVENTION

1. Field of the Invention

The present invention relates to an array substrate, and a liquid crystal panel comprising the array substrate.

2. Description of the Related Art

In general, liquid crystal display panels comprise an array substrate, a counter substrate arranged opposite to the array substrate with a predetermined gap therebetween, and a liquid crystal layer held between the substrates. As shown in, for example, Jpn. Pat. Appln. KOKAI Publication No. 2005-70442, the array substrate includes a glass substrate, an underlayer formed on the glass substrate, and a plurality of columnar spacers and an alignment film formed on the underlayer. The underlayer is formed of a plurality of signal lines, scanning lines, thin film transistors (TFTs) and pixel electrodes, and a color filter, etc.

The signal lines and scanning lines are arranged in a grating. The TFTs are provided near the intersections of the signal and scanning lines. The color filter is provided on the glass substrate, signal lines, scanning lines and TFTs. The color filter is formed of a plurality of red layers, green layers and blue layers arranged alternately and adjacently. The pixel electrodes are formed on the colored layers and have a desired shape. The pixel electrodes are electrically connected to the TFTs via contact holes formed in the colored layers. The columnar spacers are formed on the colored layers, and an alignment film is formed on the colored layers and pixel electrodes.

On the other hand, the counter substrate includes a glass substrate, and a counter electrode and alignment film formed in this order on the glass substrate.

The array substrate and counter substrate are bonded to each other by a sealing member provided on the peripheral portions of the substrates. The liquid crystal layer is provided in the space surrounded by the array substrate, counter substrate and sealing member.

In general, those portions of the underlayer, in which signal lines, scanning lines and TFTs overlap each other, and the peripheral portions of adjacent colored layers overlap each other, are thicker than the other portions. Thus, the thickness of the underlayer is not uniform. The nonuniform thickness of the underlayer causes a nonuniform cell gap, resulting in the degradation of the display quality of the liquid crystal display panel. Further, even if the colored layers are made by a multi-gap method for making the colored layers to different thicknesses to thereby make the thickness of the liquid crystal layer nonuniform, and then columnar spacers are formed on the resultant colored layers, a nonuniform cell gap inevitably occurs. Thus, even in this case, the display quality of the liquid crystal display panel is degraded.

### BRIEF SUMMARY OF THE INVENTION

The present invention has been made in view of the foregoing. An object of the invention is to provide an array substrate that enables a liquid crystal display panel excellent in display quality to be produced, and a liquid crystal display panel excellent in display quality.

To achieve the object, in accordance with an aspect of the invention, there is provided an array substrate comprising:

a substrate;

an underlayer including a plurality of switching elements formed on the substrate, a plurality of colored layers formed on the substrate and the switching elements, and a plurality of pixel electrodes provided on the colored layers and connected to the switching elements via contact holes formed in the colored layers; and

a plurality of columnar spacers provided on the underlayer,

wherein:

the underlayer includes a plurality of same-structure portions extending perpendicular to the substrate; and

the columnar spacers are provided on the same-structure portions.

In accordance with another aspect of the invention, there is provided a liquid crystal display panel comprising:

an array substrate including a substrate, an underlayer including a plurality of switching elements formed on the substrate, a plurality of colored layers formed on the substrate and the switching elements, and a plurality of pixel electrodes provided on the colored layers and connected to the switching elements via contact holes formed in the colored layers, and a plurality of columnar spacers provided on the underlayer;

a counter substrate arranged opposite to the array substrate with a gap therebetween by the columnar spacers; and

a liquid crystal layer held between the array substrate and the counter substrate,

wherein:

the underlayer includes a plurality of same-structure portions extending perpendicular to the substrate; and

the columnar spacers are provided on the same-structure portions.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view illustrating a liquid crystal display panel according to an embodiment of the invention;

FIG. 2 is a sectional view the liquid crystal display panel;

FIG. 3 is a schematic plan view illustrating the wiring structure of the liquid crystal display panel;

FIG. 4 is a sectional view illustrating the liquid crystal display panel, and in particular, the relationship between the underlayer and columnar spacers employed in the panel;

FIG. 5 is a plan view illustrating the array substrate, and in particular, the relationship between the underlayer and columnar spacers employed in the panel;

FIG. 6 is a sectional view illustrating a liquid crystal display panel according to another embodiment of the invention, and in particular, the relationship between the underlayer and columnar spacers employed in the panel; and

FIG. 7 is a plan view illustrating the array substrate appearing in FIG. 6, and in particular, the relationship between the underlayer and columnar spacers employed in the panel.

### DETAILED DESCRIPTION OF THE INVENTION

Liquid crystal display panel according to embodiments of the invention will be described in detail with reference to the accompanying drawings.

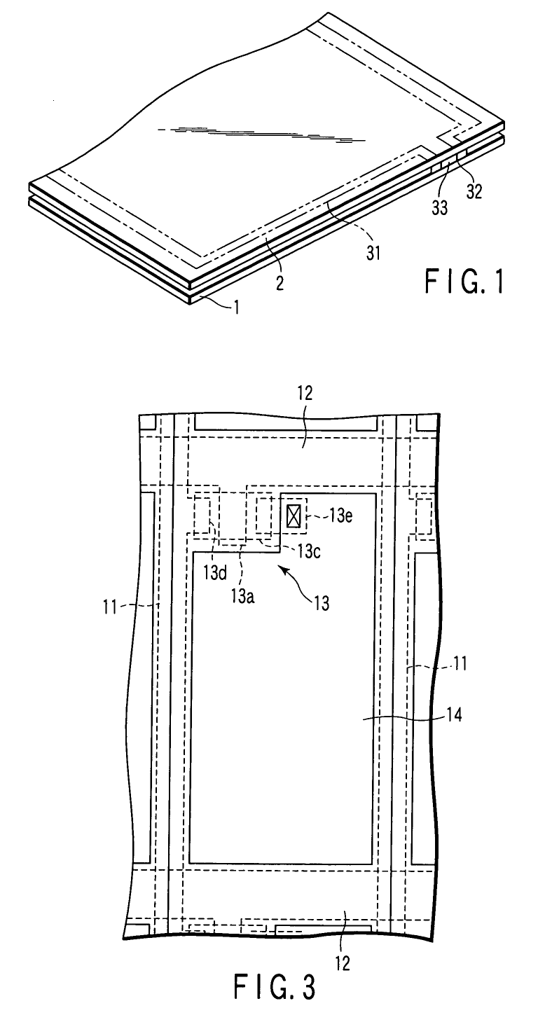

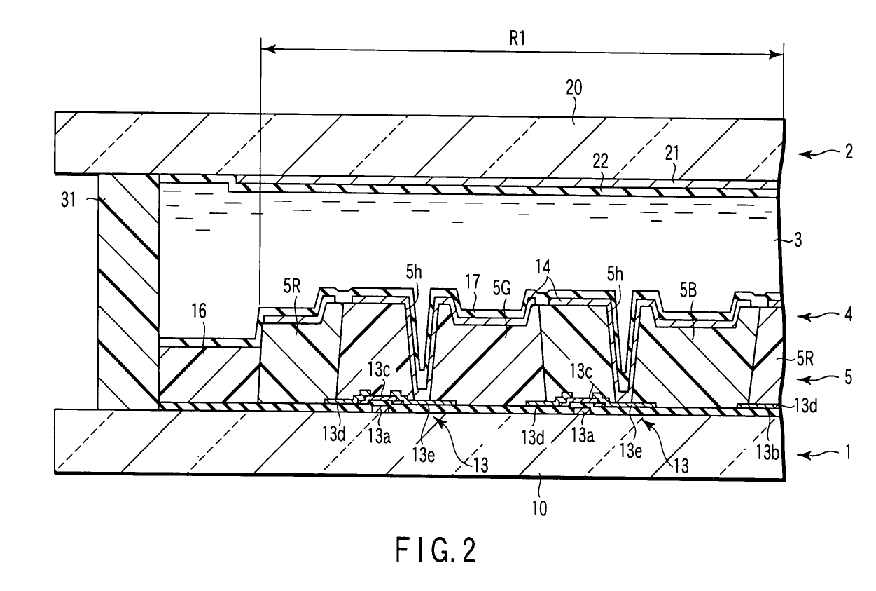

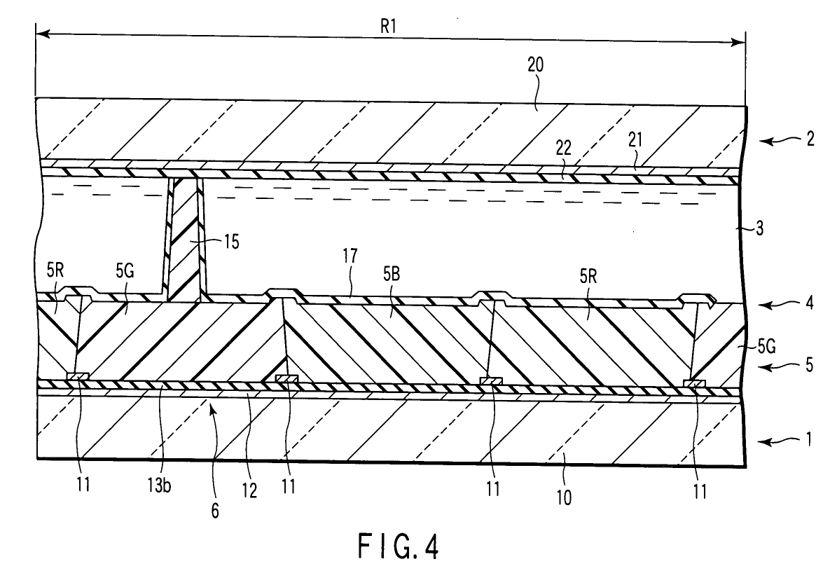

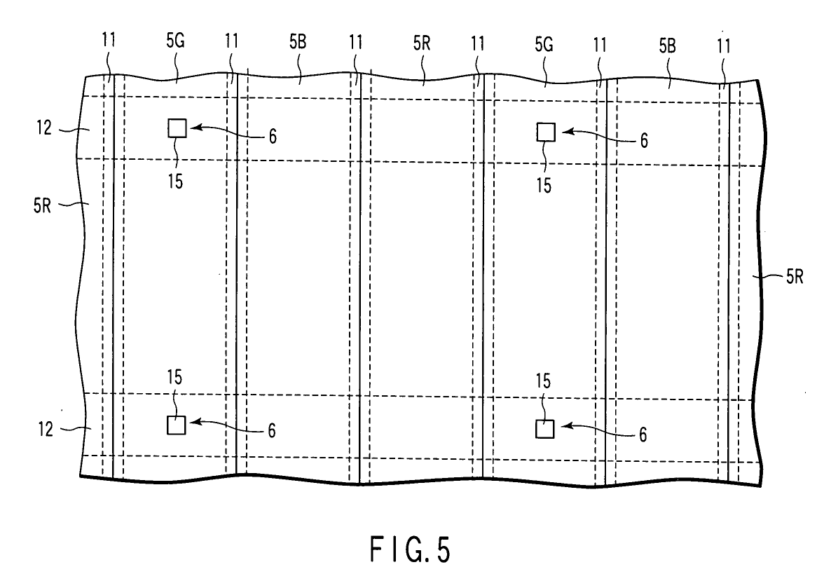

As shown in FIGS. 1 to 5, a liquid crystal display panel comprises an array substrate 1 having a display region R1, a counter substrate 2 arranged opposite to the array substrate 1 with a predetermined gap therebetween, and a liquid crystal layer 3 held between the array substrate and counter substrate.

The array substrate 1 comprises a glass substrate 10 as a transparent insulating substrate, an underlayer 4 formed on the glass substrate, a plurality of columnar spacers 15 formed on the underlayer, and an alignment film 17 formed on the underlayer.

A plurality of signal lines 11 and scanning lines 12 as wiring members are arranged in a grating on the glass substrate 10, and switching elements formed of, for example, TFTs 13 are provided near the intersections of the signal and scanning lines.

Each TFT 13 includes a gate electrode 13a formed of an extended part of the scanning line 12, a gate insulating film 13b formed on the gate electrode, a semiconductor film 13c opposing the gate electrode with the gate insulating film, a source electrode 13d connected to an end of the semiconductor film, and a drain electrode 13e connected to the other end of the semiconductor film. Each source electrode 13d is connected to the signal line 11, and each drain electrode 13e is connected to the pixel electrode 14, described later.

In the display region R1, red-colored layers 5R as first colored layers, blue-colored layers 5B as second colored layers and green-colored layers 5G as third colored layers, respectively, are alternately and adjacently arranged on the glass substrate 10, the signal and scanning lines 11 and 12, and TFTs 13. The colored layers 5R, 5G and 5B are formed in strips and provide a color filter 5. The adjacent edges of the colored layers 5R, 5G and 5B overlap with the signal lines 11. In this embodiment, the colored layers 5R, 5G and 5B have a thickness of 3.0±0.3 μm.

A plurality of pixel electrodes 14 formed of transparent conductive films, such as indium tin oxide (ITO) films, are provided on the colored layers 5R, 5G and 5B. Each pixel electrode 14 is electrically connected to the drain electrode 13e of the corresponding TFT 13 via a contact hole 5h formed in the corresponding colored layer. In the embodiment, the underlayer 4 is formed of the signal lines 11, scanning lines 12, TFTs 13, pixel electrodes 14 and colored layers 5R, 5G and 5B. Further, the underlayer 4 includes a plurality of same-structure portions 6 extending in the direction perpendicular to the glass substrate 10.

The columnar spacers 15 are provided on the same-structure portions 6 of the underlayer 4. More specifically, the columnar spacers 15 are provided on the layers of the same color on the scanning lines 12. In the embodiment, the columnar spacers 15 are provided on the colored layers 5G on the scanning lines 12. In this case, each same-structure portion 6 is formed of the scanning line 12 and colored layer 5G. The ideal height of the columnar spacers 15 is set to 5.2 μm, and the actual height of the columnar spacers 15 was 5.2±0.15 μm.

The alignment film 17 is provided on the underlayer 4 on which the columnar spacers 15 are formed.

A rectangular frame-shaped light shielding section 16 is provided on the glass substrate 10 outside the display region R1. The light shielding section 16 is provided along the entire periphery of the colored layers in the display region R1. The light shielding section 16 prevents light from leaking from the periphery of the display region R1. The alignment film 17 is provided on the entire surface of the glass substrate 10 that includes both the display region R1 and the region outside it.

The counter substrate 2 comprises a glass substrate 20 as a transparent insulating substrate. A counter electrode 21 formed of a transparent conductive film, such as an ITO film, is provided on the glass substrate 20. An alignment film 22 is provided on the counter electrode 21 in the display region R1 and also on the region outside the display region R1. Namely, the alignment film 22 is provided on the entire surface of the glass substrate 20.

The array substrate 1 and counter substrate 2 are arranged opposite to each other with a predetermined gap therebetween by the columnar spacers 15. The array substrate 1 and counter substrate 2 are bonded to each other by a sealing member 31 provided on the peripheries of the substrates. The sealing member 31 is provided on the outer periphery of the light shielding section 16. The liquid crystal layer 3 is held between the array substrate 1 and counter substrate 2. A liquid crystal inlet 32 formed in a section of the sealing member 31 is sealed with a sealant 33.

Next, the structure of the above-described liquid crystal display panel will now be described in more detail, together with its manufacturing method.

Firstly, signal lines 11, scanning lines 12 and TFTs 13 are formed on a prepared glass substrate 10 by a standard manufacturing process such as repeating film formation and patterning.

Subsequently, a photosensitive green resist (hereinafter referred to simply as “the green resist”) dispersed with a green pigment as an organic pigment is formed on the glass substrate 10. After that, the green resist is exposed to light using a photomask, developed and baked. Thus, colored layers 5G are formed in the display region R1. At the same time, contact holes 5h are formed in the colored layers 5G. Thereafter, in the same manner as the colored layers 5G, colored layers 5R and 5B are successively formed adjacent to each other in the display region R1, and contact holes 5h are formed in the colored layers 5R and 5B. Thus, the colored layers 5R, 5G and 5B having a thickness of 3.0±0.3 μm.

The order of forming the colored layers 5R, 5G and 5B is not limited to the above. It may be determined depending upon the characteristics of each colored layer. Further, in light of productivity, it is preferable to use a proximity exposure device for photolithography. Alternatively, a mirror projection exposure device may be used for enhancing the accuracy of patterning.

Subsequently, ITO is deposited by sputtering on the colored layers 5R, 5G and 5B. The deposited ITO is patterned by photolithography into a plurality of pixel electrodes 14 formed on the colored layers and connected to the contact holes 5h. Each pixel electrode 14 is formed in the region defined by the corresponding pair of adjacent ones of the signal lines 11 and the corresponding pair of adjacent ones of the scanning lines 12.

After forming the pixel electrodes 14, a photosensitive black resist (hereinafter referred to simply as “the black resist”) as a light shielding material is coated on the resultant glass substrate 10 by a spinner. Thereafter, the black resist is dried, then patterned by photolithography, developed and baked. As a result, light shielding section 16 is formed.

After that, a resist is coated on the resultant glass substrate 10 and exposed to light. The resultant resist is developed and baked, with the result that a plurality of columnar spacers 15 with a height of 5.2±0.15 μm are formed on the portions of the colored layers 5G that are not placed on the pixel electrodes 14 but are placed on the scanning lines 12.

Although in the embodiment, the same-structure portions 6 are formed of the scanning lines 12 and colored layers 5G, they may be formed of colored layers of an arbitrary color.

The scanning lines 12 and colored layers 5G are simultaneously formed under the same conditions. Namely, the columnar spacers 15 are formed on those portions of the underlayer 4 that are formed under the same conditions. This makes uniform the height from the surface of the glass substrate 10 to the top of the columnar spacers 15. Thus, an array substrate 1 with small variations in the height can be acquired. In the embodiment, the ideal height of the columnar spacers 15 is set to 5.2 μm. However, the ideal height is not limited to this, but may be changed in accordance with the specifications of the liquid crystal display panel. Subsequently, an alignment film 17 is formed on the entire surface of the glass substrate 10 that includes the display region R1, and is subjected to an alignment film treatment processing (rubbing). As a result, the array substrate 1 is completed.

On the other hand, for producing a counter substrate 2, firstly, a glass substrate 20 is prepared. On the glass substrate 20, ITO is deposited by, for example, sputtering, thereby forming a counter electrode 21. Subsequently, an alignment film 22 is formed on the entire surface of the glass substrate 20 that includes the display region R1, and is subjected to an alignment film treatment processing (rubbing). As a result, the counter substrate 2 is completed.

After that, a sealing member 31 of, for example, a thermosetting type is printed on the periphery of the glass substrate 20. The resultant array substrate 1 and counter substrate 2 are arranged opposite to each other with a predetermined gap therebetween by the columnar spacers 15, whereby the peripheries of the array substrate 1 and counter substrate 2 are bonded to each other by the sealing member 31. In this state, the sealing member 31 is heated and hardened to fix the array substrate 1 and counter substrate 2.

Subsequently, with a vacuum injection method, a liquid crystal is injected between the array substrate 1 and counter substrate 2 through the liquid crystal inlet 32 formed in a section of the sealing member 31. After that, the liquid crystal inlet 32 is sealed by a sealant 33 formed of, for example, an ultraviolet curing resin. Thus, the liquid crystal is sealed between the array substrate 1 and counter substrate 2, whereby a liquid crystal layer 3 is formed. The thus-acquired liquid crystal display panel has a cell gap variation of ±0.2 μm or less.

In the liquid crystal display panel constructed as the above, the columnar spacers 15 are provided on the same-structure portions 6 of the underlayer 4. The scanning lines 12 and colored layers 5G are simultaneously formed under the same conditions. Namely, the columnar spacers 15 are formed on those portions of the underlayer 4 that are formed under the same conditions. This makes uniform the height from the surface of the glass substrate 10 to the top of the columnar spacers 15. Thus, an array substrate 1 with small variations in the height can be acquired.

As a result, a liquid crystal display panel having a cell gap variation of ±0.2 μm or less can be acquired, and degraded display due to a large cell gap variation can be avoided. Thus, a liquid crystal display panel of excellent display quality can be acquired.

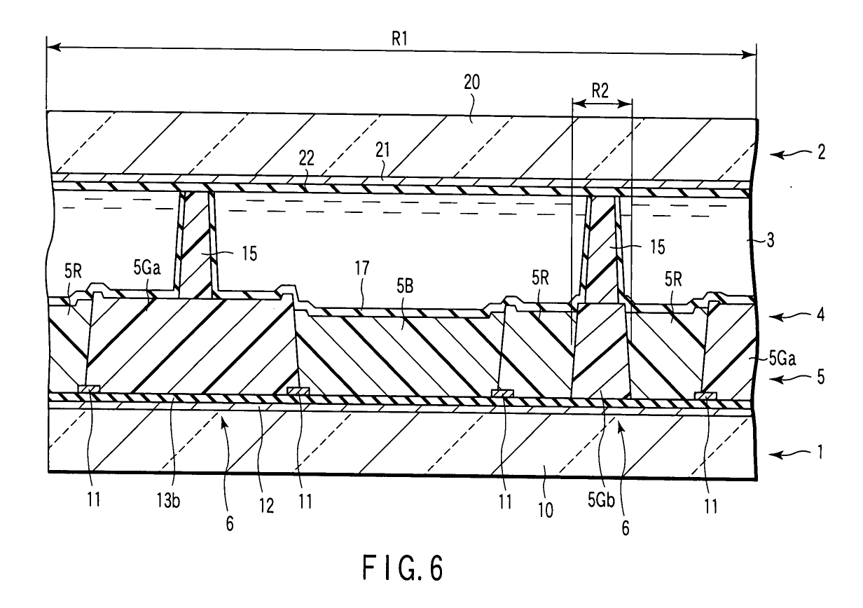

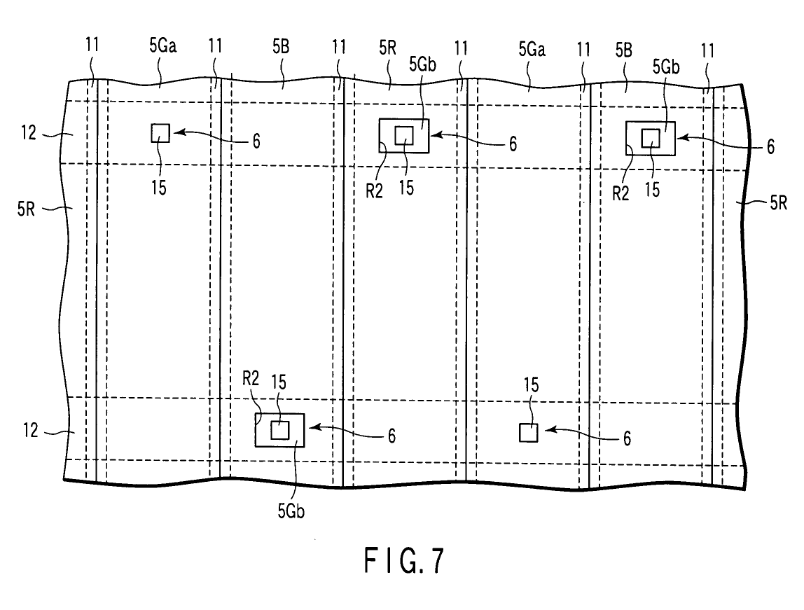

Referring then to FIGS. 6 and 7, a liquid crystal display panel according to another embodiment of the invention will be described in detail. This embodiment has the same structure as that of the above-described embodiment except for the following points. Only the different points will be described in detail.

Colored layers 5R, 5Ga (5Gb) and 5B incorporated in the color filter 5 have different thicknesses. The colored layers 5Ga and 5Gb have the greatest thickness, and the thicknesses of the colored layers 5Ga (5Gb), 5R and 5B are decreased in this order. The colored layers 5R and 5B are formed in the regions other than the regions in which the colored layers 5Ga and 5Gb are formed, and other than superposed regions R2 in which same-structure portions 6 are formed.

In the superposed regions R2, the same-structure portions 6, scanning lines 12 and columnar spacers 15 are formed. The colored layers 5Gb are formed in the superposed regions R2. In other words, parts of the green-colored layers are formed in the regions, which are located within the regions of the colored layers 5R and 5B, and in which the colored layers 5R or 5B are not formed.

The columnar spacers 15 are provided on the colored layers 5Ga and the colored layers 5Gb formed in the superposed region R2. The ideal height of the columnar spacers 15 is set to 5.2 μm, and the actual height of the columnar spacers 15 was 5.2±0.15 μm.

Next, the structure of the above-described liquid crystal display panel will be described in more detail, together with its manufacturing method. In particular, manufacturing method of the color filter 5 and columnar spacers 15 will be described.

Firstly, signal lines 11, scanning lines 12 and TFTs 13 are formed on a prepared glass substrate 10 by a standard manufacturing process such as repeating film formation and patterning.

Subsequently, a green resist is formed on the glass substrate 10, then exposed to light using a photomask, developed and baked. Thus, colored layers 5Ga in the display region R1. At the same time, contact holes 5h are formed in the colored layers 5Ga, and the colored layers 5Gb are formed in the superposed regions R2. Namely, the colored layers 5Ga, and the colored layers 5Gb in the superposed regions R2 are simultaneously formed under the same conditions.

After that, in the same manner as the colored layers 5Ga, red-colored layers 5R and blue-colored layers 5B are successively formed adjacent to each other in the display region R1, and contact holes 5h are formed in the colored layers 5R and 5B. At this time, the colored layers 5R and 5B are not formed in the regions R2. As a result, colored layers 5R, 5Ga (5Gb) and 5B of different thicknesses are formed. Thereafter, a plurality of pixel electrodes 14 and a light shielding section 16 are formed in the same manner as employed in the first-mentioned embodiment.

After that, a resist is coated on the resultant glass substrate 10 and exposed to light. The resultant resist is developed and baked, with the result that a plurality of columnar spacers 15 are formed on the portions of the colored layers 5Ga that are placed on the scanning lines 12, and on the colored layers 5Gb formed in the superposed regions R2 on the scanning lines 12. Although in this embodiment, the same-structure portions 6 are formed of the scanning lines 12 and colored layers 5Ga and 5Gb, they may be formed of colored layers of an arbitrary color.

The scanning lines 12 are simultaneously formed under the same conditions. The colored layers 5Ga and 5Gb are simultaneously formed under the same conditions. Namely, the columnar spacers 15 are formed on those portions of the underlayer 4 that are formed under the same conditions. This makes uniform the height from the surface of the glass substrate 10 to the top of the columnar spacers 15. Thus, an array substrate 1 with small variations in the height can be acquired. In this embodiment, the ideal height of the columnar spacers 15 is set to 5.2 μm. However, the ideal height is not limited to this, but may be changed in accordance with the specifications of the liquid crystal display panel. Subsequently, an alignment film 17 is formed on the glass substrate 10, thereby completing the array substrate 1.

On the other hand, the counter substrate 2 is produced in the same way as in the first-mentioned embodiment. As a result, the counter substrate 2 is completed.

Subsequently, the array substrate 1 and counter substrate 2 are arranged opposite to each other with a predetermined gap therebetween by the columnar spacers 15, whereby the peripheral portions of the array substrates 1 and counter substrate 2 are bonded to each other by a sealing member 31. Thus, the array substrate 1 and counter substrate 2 are fixed to each other.

After that, a liquid crystal is injected between the array substrate 1 and counter substrate 2 through a liquid crystal inlet 32 formed in a section of the sealing member 31, and then the liquid crystal inlet 32 is sealed by a sealant 33. Thus, a liquid crystal layer 3 is formed between the array substrate 1 and counter substrate 2. This is the completion of a liquid crystal display panel with a cell gap variation of ±0.2 μm or less.

In the liquid crystal display panel constructed as the above, the columnar spacers 15 are provided on the same-structure portions 6 of the underlayer 4. The scanning lines 12 are simultaneously formed under the same conditions. The colored layers 5Ga and 5Gb are simultaneously formed under the same conditions. Namely, the columnar spacers 15 are formed on those portions of the underlayer 4 that are formed under the same conditions. This makes uniform the height from the surface of the glass substrate 10 to the top of the columnar spacers 15. Thus, an array substrate 1 with small variations in the height can be acquired.

As a result, a liquid crystal display panel having a cell gap variation of ±0.2 μm or less can be acquired, and degraded display due to a large cell gap variation can be avoided. Thus, a liquid crystal display panel of excellent display quality can be acquired.

The invention is not limited to the above-described embodiments, but may be modified in various ways without departing the scope. Further, various inventions can be derived from appropriate combinations of the structural elements disclosed in the embodiments. For instance, some may be deleted from the structural elements of the embodiments. Further, structural elements employed in the two embodiments may be combined appropriately.

Specifically, the colored layers incorporated in the same-structure portions 6 contained in the underlayer 4 are not limited to the green-colored layers. If the columnar spacers 15 are formed on the portions in the underlayer 4 that have the same structure, the same advantage as the above can be acquired.

What is claimed is:

1. An array substrate comprising:
a substrate;
an underlayer including a plurality of switching elements formed on the substrate, a plurality of colored layers formed on the substrate and the switching elements, and a plurality of pixel electrodes provided on the colored layers and connected to the switching elements via contact holes formed in the colored layers; and
a plurality of columnar spacers provided on the underlayer,
wherein:
the underlayer includes a plurality of same-structure portions extending perpendicular to the substrate; and
the columnar spacers are provided on the same-structure portions.

2. The array substrate according to claim 1, wherein the same-structure portions include certain colored layers of a same color included in the colored layers.

3. The array substrate according to claim 1, wherein:
the colored layers includes first colored layers, second colored layers and third colored layers arranged alternately and adjacently;
the same-structure portions include the third colored layers; and
parts of the third colored layers are provided in regions, which are located within regions of the first and second colored layers, and in which the first or second colored layers are not formed.

4. The array substrate according to claim 1, wherein:
the underlayer includes a plurality of wiring members provided on the substrate; and
the same-structure portions include the wiring members, and certain colored layers of a same color included in the colored layers.

5. A liquid crystal display panel comprising:
an array substrate including a substrate, an underlayer including a plurality of switching elements formed on the substrate, a plurality of colored layers formed on the substrate and the switching elements, and a plurality of pixel electrodes provided on the colored layers and connected to the switching elements via contact holes formed in the colored layers, and a plurality of columnar spacers provided on the underlayer;
a counter substrate arranged opposite to the array substrate with a gap therebetween by the columnar spacers; and
a liquid crystal layer held between the array substrate and the counter substrate,
wherein:
the underlayer includes a plurality of same-structure portions extending perpendicular to the substrate; and
the columnar spacers are provided on the same-structure portions.
